(19) United States
(12) Patent Application Publication
(10) Pub. No.: US 2006/0061716 A1
(43) Pub. Date: Mar. 23, 2006

(54) Electro-optical device, method of manufacturing the same, and electronic apparatus

(76) Inventors: Yoshio Yamaguchi, Matsumoto (JP); Takeshi Kurashima, Toyoshina (JP)

Correspondence Address: HARNESS, DICKEY & PIERCE, P.L.C., P.O. BOX 828, BLOOMFIELD HILLS, MI, 48303, US

(21) Appl. No.: 11/214,614

(22) Filed: Aug. 30, 2005

(30) Foreign Application Priority Data
Sep. 21, 2004 (JP) 2004-272890

(51) Int. Cl. G02F 1/1335

(52) U.S. Cl. 349/114

(57) ABSTRACT

An electro-optical device includes a pair of substrates with an electro-optical material layer interposed therebetween, and a plurality of pixels, each having a reflection region and a transmission region. The reflection regions are disposed on opposing sides of adjacent pixels. On one substrate of the pair of substrates, an insulating layer is formed in the reflection region, such that the thicknesses of the electro-optical material layer in the reflection region and the transmission region are made different from each other. Further, the insulating layer is formed across two adjacent pixels along a direction in which the reflection regions of adjacent pixels continue.

### BACKGROUND OF THE INVENTION

1. Technical Field

The present invention relates to an electro-optical device, to a method of manufacturing such an electro-optical device, and to an electronic apparatus. More particularly, the present invention relates to an electro-optical device in which alignment defects caused by multi-gap steps are reduced, to a method of manufacturing such an electro-optical device, and to an electronic apparatus having such an electro-optical device.

2. Related Art

Conventionally, as image display devices, liquid crystal display devices have been widely used. In the liquid crystal display devices, a pair of substrates are disposed to face each other, each substrate having electrodes formed thereon. Then, when a voltage to be applied to a plurality of pixels which are intersections between the electrodes is selectively turned on and off, light passing through a liquid crystal material of a pixel region is modulated, such that an image, a character or the like is displayed.

In addition, as such liquid crystal display devices, there is provided a transflective liquid crystal display device capable of performing reflective display and transmissive display. That is, in a transmission region, light irradiated from a backlight disposed on the rear side of the substrate is incident on a liquid crystal panel and passes through a liquid crystal material layer to be viewed from the outside. On the other hand, in a reflection region, external light incident on the liquid crystal panel from the outside passes through a liquid crystal material layer. Then, light is reflected by a light reflecting film and passes through the liquid crystal material layer again to be viewed from the outside. With the transmission region and the reflection region, image display can be recognized by use of external light, such as sunlight, at daytime or in a bright place, such that power consumption can be reduced. At night or in a dark place, image display can be recognized by the backlight.

In the transflective liquid crystal display device, a reflection region R and a transmission region T in one pixel G are disposed, as shown in FIGS. 16A to 16C. FIG. 16A shows an example in which the transmission region T is disposed in the center of each pixel G and the reflection region R is disposed in the peripheral portion thereof. Further, FIG. 16B shows an example in which the reflection region R is disposed in an upper half portion of each pixel G and the transmission region T is disposed in a lower half portion thereof. In addition, FIG. 16C shows an example in which the reflection regions R are disposed at the top and bottom in each pixel G and the transmission region T is interposed therebetween.

In addition, as the transflective liquid crystal display device, a liquid crystal display device having a so-called multi-gap structure has been suggested in which coloring is excellent in the transmissive display and the reflective display, respectively, and appropriate retardation is easily made. More specifically, as shown in FIG. 17, a transflective liquid crystal display device has been suggested in which a light reflecting layer 604 is formed in a pixel 603 so as to define a reflection region 631 and a transmission region 632 and, on the light reflecting layer 604, a layer-thickness adjusting layer 606 is formed to have an opening 661 corresponding to the transmission region 632 (for example, see Japanese Unexamined Patent Application Publication No. 2003-270627

### SUMMARY

The inventors determined that a liquid crystal display device having the multi-gap structure, such as the liquid crystal display device disclosed in Japanese Unexamined Patent Application Publication No. 2003-270627, may contain a step (height difference) in the layer-thickness adjusting layer corresponding to the boundary between the reflection region and the transmission region. This step can cause alignment defects in a liquid crystal material. That is, when the reflection region R and the transmission region T are disposed as shown in FIGS. 16A to 16C, a step is formed along the boundary between the reflection region and the transmission region. Accordingly, as the number of sides of the step included in one pixel is increased (high area ratio), display characteristics, such as contrast or the like, may be degraded in an image to be displayed.

An advantage of the invention is that it provides an electro-optical device in which the number of sides of a step of an insulating layer included in one pixel is reduced, thereby preventing alignment defects from occurring. Another advantage of the invention is that it provides a method of manufacturing such an electro-optical device and an electronic apparatus having such an electro-optical device.

According to a first aspect of the invention, an electro-optical device includes a pair of substrates with an electro-optical material layer interposed therebetween, and a plurality of pixels, each having a reflection region and a transmission region. The reflection regions are disposed on opposing sides of adjacent pixels. On one substrate of the pair of substrates, an insulating layer is formed in the reflection region, such that the thicknesses of the electro-optical material layer in the reflection region and the transmission region are made different from each other. Further, the insulating layer is formed across two adjacent pixels along a direction in which the reflection regions of adjacent pixels continue.

That is, by adjusting the thickness of the electro-optical material layer to reduce the thickness of the electro-optical material layer in the reflection region, the insulating layer is formed across two adjacent pixels along a predetermined direction, such that the step of the insulating layer included in one pixel can be reduced. Therefore, retardation is optimized in the reflection region and the transmission region, respectively. Further, it is possible to provide an electro-optical device in which alignment defects of the electro-optical material caused by the step of the insulating layer are reduced and display characteristics of an image to be displayed can be enhanced.

In the electro-optical device according to the first aspect of the invention, it is preferable that the insulating layer be formed in a stripe shape across the pixels that are arranged along a direction orthogonal to the direction in which the reflection regions of adjacent pixels continue.

According to this configuration, the step, which is formed along the predetermined direction in the insulating layer, can be removed. Therefore, the step of the insulating layer included in one pixel can be further reduced, such that display characteristics can be further enhanced.

In the electro-optical device according to the first aspect of the invention, it is preferable that the step of the insulating layer be formed in a tapered shape.

According to this configuration, adherence of other members, which are formed in the step of the insulating layer, can be enhanced. For example, there is no case in which transparent electrodes are disconnected, and thus defective display can be prevented from occurring.

In the electro-optical device according to the first aspect of the invention, it is preferable that the step of the insulating layer be formed in the reflection region.

According to this configuration, even when the alignment defects of the electro-optical material caused by the step of the insulating layer occur, the defective display, such as light leakage or the like, in the transmissive display can be prevented from occurring.

In the electro-optical device according to the first aspect of the invention, it is preferable that a switching element be provided on one substrate to be disposed in the reflection region in each pixel.

According to this configuration, the area of the transmission region is not reduced and the switching element is easily disposed without having an influence on the characteristics of the transmissive display. In addition, when the switching element is a TFD element, a portion of the electrodes constituting the elements can be shared, such that the pixel area can be increased.

In the electro-optical device according to the first aspect of the invention, it is preferable that a light shielding film be formed on one of the pair of substrates to correspond to a formation region of the switching element.

According to this configuration, contrast in reflective display can be enhanced.

In the electro-optical device according to the first aspect of the invention, it is preferable that, when the transmission regions are disposed on the opposing sides of adjacent pixels, an opening of a light reflecting film is formed continuously in two adjacent pixels.

According to this configuration, the opening is easily formed and the pixel area can be increased.

According to a second aspect of the invention, an electro-optical device includes a pair of substrates with an electro-optical material layer interposed therebetween, and a plurality of pixels, each having a reflection region and a transmission region. The reflection regions are disposed on opposing sides of adjacent pixels. Further, on one substrate of the pair of substrates, an insulating layer is formed to have a thick portion corresponding to the reflection region and a thin portion corresponding to the transmission region, such that the thicknesses of the electro-optical material layer in the reflection region and the transmission region are made different from each other. In addition, the thick portion is formed across two adjacent pixels along a direction in which the reflection regions of the adjacent pixels continue.

That is, even when the thin portion of the insulating layer is also formed in the transmission region, the thick portion of the insulating layer corresponding to the reflection region is formed across two adjacent pixels along the predetermined direction, such that the step of the insulating layer included in one pixel can be reduced. Therefore, it is possible to provide an electro-optical device in which the retardation is optimized in the reflection region and the transmission region, respectively, and the alignment defects of the electro-optical material caused by the step of the insulating layer can be reduced and thus the display characteristics of an image to be displayed can be enhanced.

In the electro-optical device according to the second aspect of the invention, it is preferable that the thick portion and the thin portion in the insulating layer be formed in a stripe shape across the pixels that are arranged along a direction orthogonal to the direction in which the reflection regions of the adjacent pixels continue.

According to this configuration, even when the thin portion of the insulating layer is also formed in the transmission region, the step, which is formed along the predetermined direction, can be removed. Therefore, the insulating layer included in one pixel can be further reduced and the display characteristics can be further enhanced.

According to a third aspect of the invention, an electro-optical device includes a pair of substrates with an electro-optical material layer interposed therebetween, and a plurality of pixels, each having a reflection region and a transmission region. The reflection regions are disposed on opposing sides of adjacent pixels. Further, the electro-optical material layer has a thick layer portion corresponding to the reflection region and a thin layer portion corresponding to the transmission region. In addition, the thin layer portion is formed across two adjacent pixels along the direction in which the reflection regions of the adjacent pixels continue.

That is, in order to optimize the retardation, when the thicknesses of the electro-optical material layer in the reflection region and the transmission region are made different, the thin layer portion corresponding to the reflection region is formed across two adjacent pixels along the predetermined direction, such that the step of the electro-optical material layer included in one pixel can be reduced. Therefore, it is possible to provide an electro-optical device in which the retardation is optimized in the reflection region and the transmission region, respectively, and the alignment defects of the electro-optical material caused by the step of the electro-optical material layer can be reduced and thus the display characteristics of an image to be displayed can be enhanced.

In the electro-optical device according to the third aspect of the invention, it is preferable that the thick layer portion and the thin layer portion in the electro-optical material layer be formed in a stripe shape across the pixels that are arranged along a direction orthogonal to the direction in which the reflection regions of the adjacent pixels continue.

According to this configuration, the step of the electro-optical material layer which is formed along the predetermined direction can be reduced. Therefore, the step of the electro-optical material layer included in one pixel can be reduced and the display characteristics can be enhanced.

According to a fourth aspect of the invention, there is provided a method of manufacturing an electro-optical device, the electro-optical device having a pair of substrates with an electro-optical material layer interposed therebetween, and a plurality of pixels, each having a reflection region and a transmission region. The method of manufacturing an electro-optical device includes forming a light reflecting film on a substrate, such that the reflection regions are formed on opposing sides of adjacent pixels, and forming an insulating layer in at least the reflection region such that the thicknesses of the electro-optical material layer in the reflection region and the transmission layer are made different from each other. Here, the insulating layer is formed across two adjacent pixels along a direction in which the reflection regions of the adjacent pixels continue.

That is, since the insulating layer corresponding to at least the reflection region is simultaneously formed across two adjacent pixels along the predetermined direction, the step of the insulating layer included in one pixel is reduced, such that an electro-optical device with enhanced display characteristics can be efficiently manufactured.

According to a fifth aspect of the invention, there is provided an electronic apparatus including the above-described electro-optical device.

That is, the electronic apparatus includes the electro-optical device in which the step included in one pixel for making the thicknesses of the electro-optical material layer in the reflection region and the transmission region different is reduced. Therefore, it is possible to efficiently provide an electronic apparatus in which display characteristics are enhanced.

### BRIEF DESCRIPTION OF THE DRAWINGS

The invention will be described with reference to the accompanying drawings, wherein like numbers reference like elements, and wherein:

FIG. 1 is a schematic cross-sectional view showing a liquid crystal display device as an electro-optical device of a first embodiment of the invention;

FIG. 2A is a diagram illustrating an arrangement of reflection regions;

FIG. 2B is a diagram illustrating an arrangement of reflection regions;

FIG. 3A is a cross-sectional view showing a color filter substrate including an insulating layer;

FIG. 3B is a plan view showing a color filter substrate including an insulating layer;

FIG. 4A is a diagram showing an arrangement of openings in a light reflecting film;

FIG. 4B is a diagram showing an arrangement of openings in a light reflecting film;

FIG. 4C is a diagram showing an arrangement of openings in a light reflecting film;

FIG. 5A is a diagram illustrating an arrangement of a light shielding film;

FIG. 5B is a diagram illustrating an arrangement of a light shielding film;

FIG. 6A is a diagram illustrating the number of steps of an insulating layer included in one pixel;

FIG. 6B is a diagram illustrating the number of steps of an insulating layer included in one pixel;

FIG. 6C is a diagram illustrating the number of steps of an insulating layer included in one pixel;

FIG. 7A is a cross-sectional view illustrating a color filter substrate including an insulating layer having a thick portion and a thin portion;

FIG. 7B is a plan view illustrating a color filter substrate including an insulating layer having a thick portion and a thin portion;

FIG. 8A is a schematic plan view illustrating an element substrate;

FIG. 8B is a schematic cross-sectional view illustrating an element substrate;

FIG. 9 is a diagram illustrating an arrangement of elements;

FIG. 10A is a diagram showing a configuration of a TFD element with a shared first element electrode;

FIG. 10B is a diagram showing a configuration of a TFD element with a shared first element electrode;

FIG. 10C is a diagram showing a configuration of a TFD element with a shared first element electrode;

FIG. 11A is a diagram illustrating a manufacturing method of a color filter substrate;

FIG. 11B is a diagram illustrating the manufacturing method of a color filter substrate;

FIG. 11C is a diagram illustrating the manufacturing method of a color filter substrate;

FIG. 11D is a diagram illustrating the manufacturing method of a color filter substrate;

FIG. 11E is a diagram illustrating the manufacturing method of a color filter substrate;

FIG. 12A is a diagram illustrating the manufacturing method of a color filter substrate;

FIG. 12B is a diagram illustrating the manufacturing method of a color filter substrate;

FIG. 12C is a diagram illustrating the manufacturing method of a color filter substrate;

FIG. 13A is a diagram illustrating a manufacturing method of an element substrate;

FIG. 13B is a diagram illustrating the manufacturing method of an element substrate;

FIG. 13C is a diagram illustrating the manufacturing method of an element substrate;

FIG. 13D is a diagram illustrating the manufacturing method of an element substrate;

FIG. 13E is a diagram illustrating the manufacturing method of an element substrate;

FIG. 14A is a schematic cross-sectional view showing a liquid crystal display device according to a third embodiment of the invention;

FIG. 14B is a schematic plan view showing the liquid crystal display device according to the third embodiment of the invention;

FIG. 15 is a block diagram showing a schematic configuration of an electronic apparatus of a fourth embodiment of the invention;

FIG. 16A is a diagram illustrating an arrangement of reflection regions in an electro-optical device according to the related art;

FIG. 16B is a diagram illustrating an arrangement of reflection regions in an electro-optical device according to the related art;

FIG. 16C is a diagram illustrating an arrangement of reflection regions in an electro-optical device according to the related art;

FIG. 17A is a diagram illustrating a configuration of an electro-optical device having a multi-gap structure according to the related art;

FIG. 17B is a diagram illustrating a configuration of an electro-optical device having a multi-gap structure according to the related art; and

FIG. 17C is a diagram illustrating a configuration of an electro-optical device having a multi-gap structure according to the related art.

### DESCRIPTION OF THE EMBODIMENTS

Hereinafter, embodiments of an electro-optical device of the invention, a method of manufacturing an electro-optical device, and an electronic apparatus having an electro-optical device will be specifically described with reference to the drawings. The embodiments are just examples and are not intended to limit the invention. Various modifications can be made within the scope without departing from the spirit of the invention.

### FIRST EMBODIMENT

A first embodiment of the invention relates to an electro-optical device including a pair of substrates with an electro-optical material layer interposed therebetween, and a plurality of pixels, each having a reflection region and a transmission region. The reflection regions are formed on opposing sides of adjacent pixels. On one substrate of the pair of substrates, an insulating layer is formed in at least the reflection region, such that the thicknesses of the electro-optical material layer in the reflection region and the transmission region are made different from each other. The insulating layer is formed across two adjacent pixels along a direction in which the reflection regions of adjacent pixels continue.

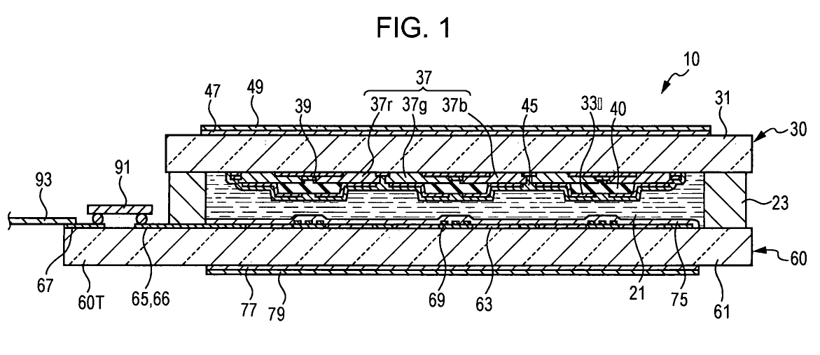

Hereinafter, the electro-optical device according to the first embodiment of the invention will be described with reference to FIGS. 1 to 10C by way of a liquid crystal device that has a color filter substrate 30 with a predetermined insulating layer 40 formed thereon and an element substrate 60 with a TFD element 69 as switching elements provided thereon.

1. Basic Structure of Electro-Optical Device

First, a basic structure of a liquid crystal display device 10 as the electro-optical device according to the first embodiment of the invention, that is, a cell structure or wiring lines, will be described specifically with reference to FIG. 1. Here, FIG. 1 is a schematic cross-sectional view showing the liquid crystal display device 10 according to the present embodiment.

The liquid crystal display device 10 includes an element substrate 60 having an active-matrix structure in which a TFD element 69 is used as a switching element, the TFD element 69 being a two-terminal nonlinear element. Although not shown in the drawing, if necessary, an illumination device, such as a backlight or a front light, and a case are properly attached to the liquid crystal display device 10.

In addition, in the liquid crystal device 10, the element substrate 60 with a glass substrate as a base substrate 61 and the color filter substrate 30 with a glass substrate as a base substrate 31 are disposed to face each other and are bonded to each other with a sealing material 23, such as an adhesive or the like. In addition, the space which is defined by the element substrate 60 and the color filter substrate 30 is provided with a cell structure in which a liquid crystal material 21 is injected inside the sealing material 23 through an opening (not shown) and the opening is sealed by an opening-sealing material (not shown). That is, between the element substrate 60 and the color substrate 30, the liquid crystal material 21 is filled.

In addition, on the inner surface of the base substrate 61 in the element substrate 60, that is, on the surface opposite to the color filter substrate 30, a plurality of pixel electrodes 63 are formed to be disposed in a matrix shape. On the inner surface of the base substrate 31 in the color filter substrate 30, that is, on the surface opposite to the element substrate 60, a plurality of scanning electrodes 33 are formed to be disposed in a stripe shape. The pixel electrodes 63 are electrically connected to data lines 65 through the TFD elements 69 as switching elements, while the scanning electrodes 33 are electrically connected to relay wiring lines (not shown) on the element substrate 60 via the sealing material 23 including conductive particles. The intersections between the pixel electrodes 63 and the scanning electrodes 33 constituted in such a manner constitute a plurality of pixels (hereinafter, in some cases, referred to as a pixel region) arranged in a matrix shape, and the arrangement of the plurality of pixels constitutes a display region as a whole. Therefore, when a voltage is applied to desired pixels, an electric field is generated in the liquid crystal material 21 of the pixels, such that an image, such as a character or a figure, can be displayed on the entire display region.

In addition, the element substrate 60 has a substrate extended portion 60T which extends outward than the color filter substrate 30. On the substrate extended portion 60T, external connection terminals 67 are formed, which are constituted by the data lines 65, the relay wiring lines (not shown), and a plurality of wiring lines formed separately.

At the ends of the data lines 65 or the relay wiring lines (not shown), a driving semiconductor element (driving IC) 91, which is built in a liquid crystal driving circuit, is mounted. Further, at the ends of the outer connection terminal 67 near the display region, the driving semiconductor element (driving IC) 91 is also mounted and, at the other ends, a flexible circuit board 93 is mounted.

2. Reflection Region and Transmission Region

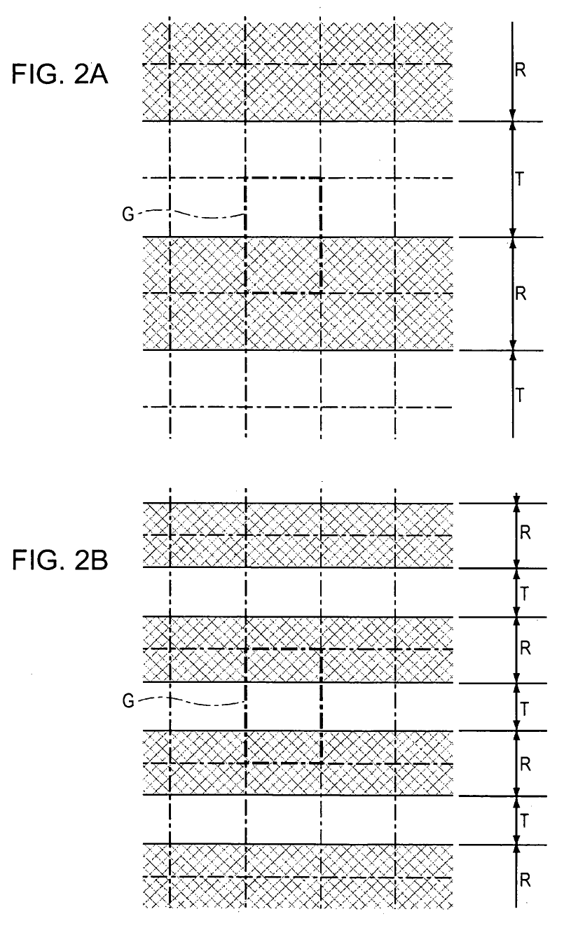

In addition, in the electro-optical device according to the invention which is a transflective electro-optical device, reflection regions R are disposed on opposing sides of adjacent pixels G. That is, in the case of the liquid crystal display device 10 having the TFD elements 69 according to the present embodiment, the reflection regions R are disposed on opposing sides of adjacent pixels G in a direction along the data lines 65 on the element substrate 60, as shown in FIGS. 2A and 2B. For example, in FIG. 2A, a pixel G where a transmission region T is disposed in a upper half portion and the reflection region R is disposed in a lower half portion and a pixel G where the reflection region R is disposed in an upper half portion and the transmission region T is disposed in a lower half portion are arranged alternately. In addition, in FIG. 2B, in each pixel G, the reflection regions R are disposed at the top and bottom thereof and the transmission region R is disposed therebetween.

A light reflecting film 35, in which an opening 35a is formed to correspond to the transmission region T, is provided on one of the color filter substrate 30 and the element substrate 60, such that the reflection region R and the transmission region T can be disposed in desired regions. Moreover, in the present embodiment, the liquid crystal display device 10 in which the light reflecting film 35 is formed on the color filter substrate 30 is exemplified.

3. Color Filter Substrate

(1) Basic Configuration

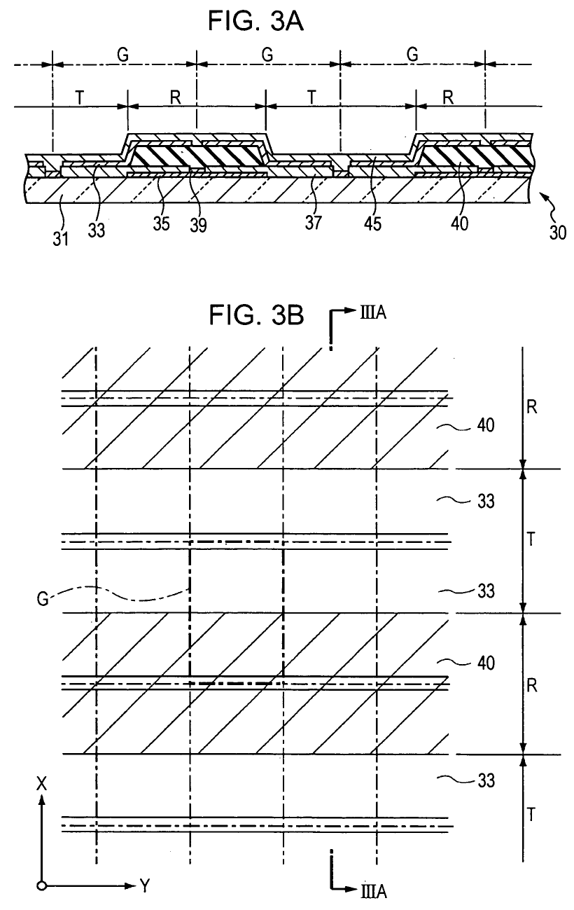

Next, the color filter substrate 30, which is used in the liquid crystal display device 10 of the present embodiment, will be described in detail with reference to FIGS. 3A to 7B.

As shown in FIGS. 3A and 3B, the color filter substrate 30 basically includes the base substrate 31 made of a glass substrate, the light reflecting film 35, a light shielding film 39, a colored layer 37, and an insulating layer 40, and the scanning electrodes 33. In addition, on the scanning electrodes 33, an alignment film 45 is provided to control the alignment of the liquid crystal material and, on the surface opposite to the surface on which the scanning electrodes 33 or the like are formed, a retardation plate 47 (quarter wave plate) and a polarizing plate 49 are disposed, such that clear display can be recognized.

(2) Light Reflecting Film

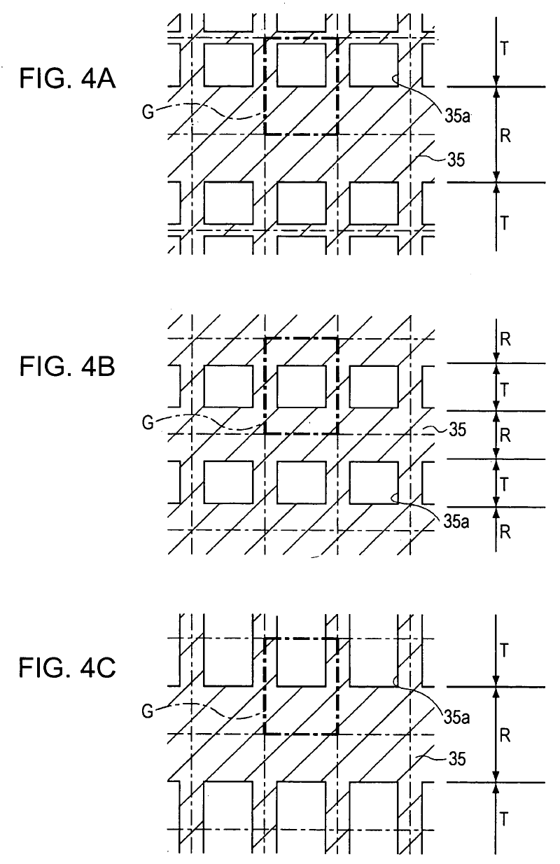

In addition, the light reflecting film 35 formed on the color filter substrate 30 is made of a metal material, such as aluminum or the like, in which the opening 35a is formed to correspond to the transmission region T. Further, the light reflecting film 35 is a member that reflects external light, such as sunlight or the like, to enable a reflective display in the reflection region R. Since the reflection regions R are disposed on the opposing sides of adjacent pixels G in the electro-optical device of the invention, the light reflecting film 35 is patterned as shown in FIGS. 4A to 4C.

In addition, when the transmission region T is disposed on the opposing sides of adjacent pixels G, the opening 35a preferably continues over two adjacent pixels G, as shown in FIG. 4C. That is because the opening 35a is easily formed and, as the region of the light reflecting film 35 is small, the opening area of the pixel G is easily expanded.

Moreover, the color filter substrate 30 shown in FIG. 3A has the light reflecting film 35 shown in FIG. 4C.

(3) Light Shielding Film

In addition, the light shielding film 39 is a film that prevents a coloring material from being mixed between adjacent pixels G, thereby obtaining image display with excellent contrast. As the light shielding film 39, a metal film, such as chromium (Cr) or molybdenum (Mo), is used. Alternatively, a material in which coloring materials of R (red), G (green), and B (blue) are dispersed in resin and other base materials, or a material in which coloring materials, such as black pigments or black dyes, are dispersed in resin and other base materials can be used. Further, the coloring materials of R (red), G (green), and B (blue) may be superimposed so as to form the light shielding film.

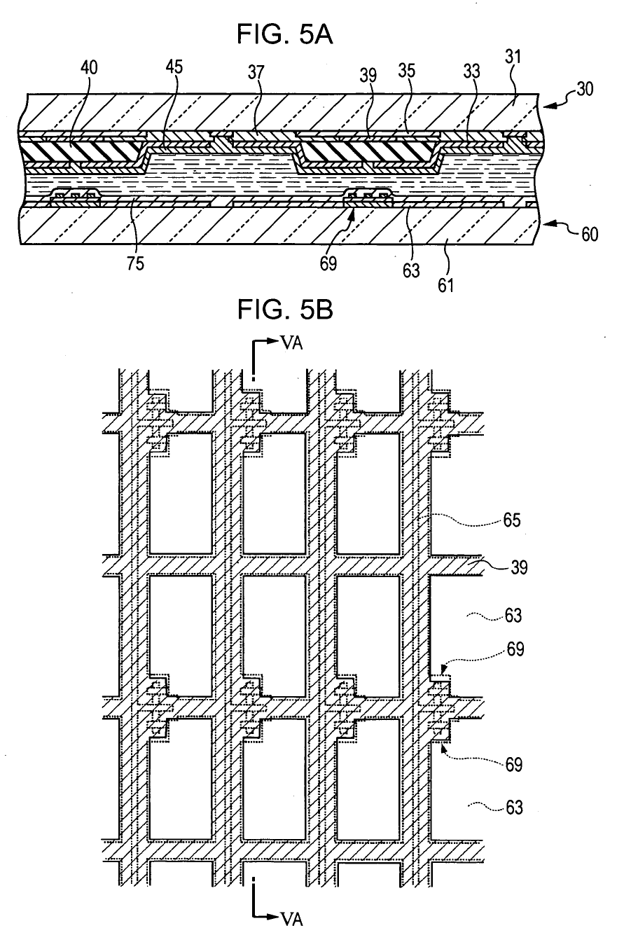

In addition, as shown in FIGS. 5A and 5B, in the liquid crystal display device 10 according to the present embodiment, the light shielding film 39 is preferably formed in a position at which the light shielding film 39 overlaps a formation region of the switching element 69, when the switching element 69 is provided on one of the pair of the substrates.

That is because light leakage of the switching element 69 on the element substrate 60 is suppressed, such that contrast can be prevented from being degraded.

Moreover, in the liquid crystal display device 10, a portion of electrodes constituting the switching elements 69 corresponding to the adjacent pixels G in a predetermined direction are shared, as described below. In this case, since the switching elements 69 are disposed close to each other, the area of the light shielding film 39 can be made small and can be disposed in a simple shape, when the light shielding film 39 is formed in a position at which the light shielding film 39 overlaps the switching element 69.

(4) Colored Layer

In addition, the colored layer 37 is generally made in such a manner that a coloring material, such as a pigment or a dye, is dispersed in transparent resin to get a predetermined color tone. As an example of the color tone of the colored layer 37, there is provided a combination of R (red), G (green), and B (blue) as a primary-color-based filter. However, the invention is not limited thereto, but the color tone of the colored layer 37 can be formed with a complementary color system of Y (yellow), M (Magenta), and C (Cyan) or as other various color tones.

In addition, as the arrangement pattern of the colored layer 37, the stripe arrangement is adopted in many cases, but various patterns, such as an oblique mosaic arrangement or a delta arrangement can be adopted, in addition to the stripe arrangement.

(5) Insulating Layer

In addition, in the liquid crystal device 10 according to the present embodiment, the insulating layer 40 made of photo-curable resin or thermosetting resin, such as acrylic resin or epoxy resin, is formed on the color filter substrate 30. As shown in FIG. 3B, the insulating layer 40 is formed in the reflection region R, such that the thicknesses of the liquid crystal material layer 21 in the reflection region R and the transmission layer T are made different from each other. The insulating layer 40 is formed across two adjacent pixels G along a direction (X direction) in which the reflection regions R of the adjacent pixels G continue.

That is, in order to optimize retardation in the reflection region R and the transmission region T, in the liquid crystal display device 10 having a multi-gap structure in which the reflection region R is a thin portion and the transmission region T is a thick portion in the liquid crystal material layer 21, the step of the insulating layer 40, which is included in one pixel G and which exists in the boundary between the reflection region R and the transmission region T, can be reduced.

According to such a configuration, alignment defects caused by the step can be prevented from occurring. While the retardation is optimized in the reflection region R and the transmission region T, respectively, the alignment defects are suppressed from occurring, such that the liquid crystal display device 10 can have excellent display characteristics.

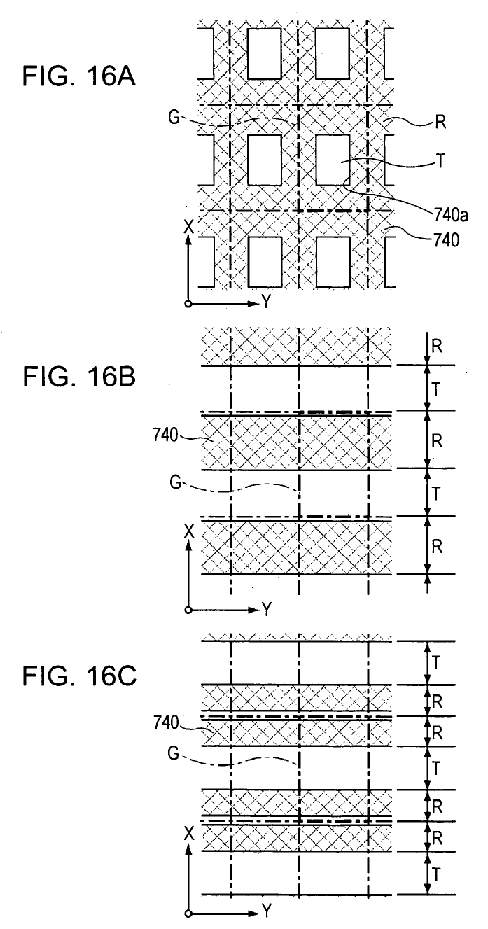

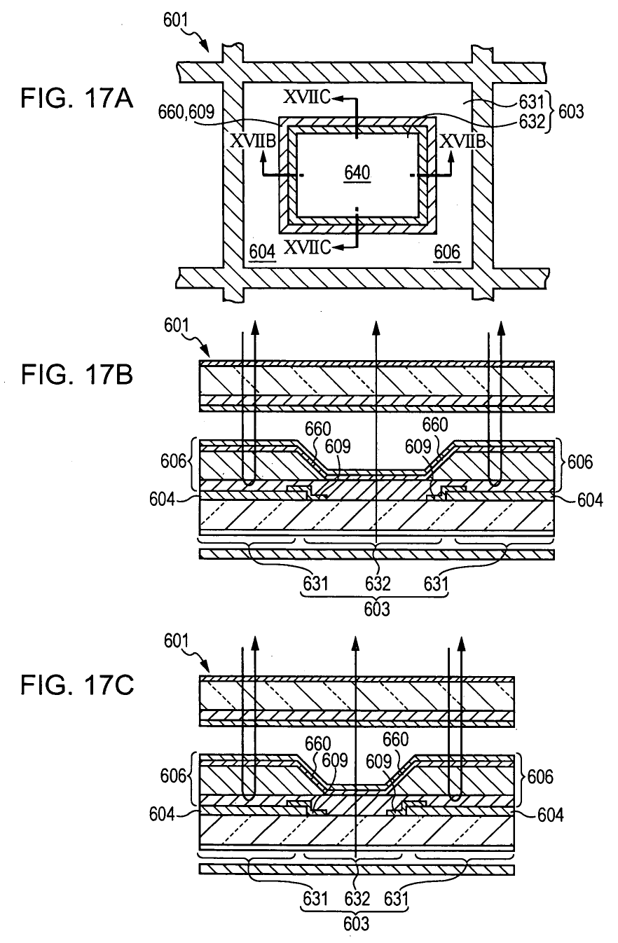

More specifically, as the shape of an insulating layer according to the related art constituting the multi-gap structure, a rectangular transmission region T is disposed in the center of each pixel G, as shown in FIG. 16A. In this case, an insulating layer 740 having an opening 740a is formed, and the step having four sides is included in one pixel G. In addition, as shown in FIG. 16B, in each pixel G, the reflection region R is disposed in the upper half portion and the transmission region T is disposed in the lower half portion. In this case, the stripe-shaped insulating layer 740 is formed across the pixels G arranged in a horizontal direction (Y direction), and two steps are included in one pixel G in the horizontal direction (the Y direction). Further, as shown in FIG. 16C, the reflection regions R are disposed at the top and bottom in each pixel G, and the transmission region T is disposed therebetween. In this case, the two stripe-shaped insulating layers 740 are formed across the pixels G arranged in the horizontal direction (the Y direction), and four steps are included in one pixel G in the horizontal direction (the Y direction).

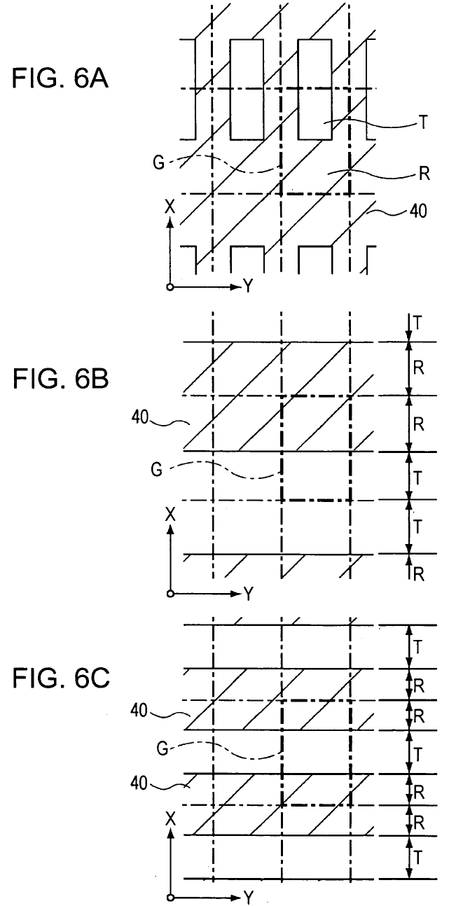

On the other hand, when the insulating layer 40 is formed across two adjacent pixels along the direction (the X direction) in which the reflection regions R of the adjacent pixels G continue, the step included in one pixel G can be reduced. That is, as shown in FIG. 6A, when the rectangular reflection region R is disposed inside each pixel G, the number of sides of the step of the insulating layer 40 included in one pixel G can be reduced from four to three. In addition, as shown in FIG. 6B, in each pixel G, the reflection region R is disposed in the upper half portion and the transmission region T is disposed in the lower half portion. In this case, the number of the steps of the insulating layer 40 included in one pixel G can be reduced from two to one. Further, as shown in FIG. 6C, the reflection regions R are disposed at the top and bottom in each pixel G and the transmission region T is disposed therebetween. In this case, the number of the steps of the insulating layer 40 included in one pixel G can be reduced from four to two.

As shown in FIGS. 6B and 6C, the insulating layer 40 across two adjacent pixels G along the predetermined direction (the X direction) is preferably formed in a stripe shape across the pixels G arranged along the direction (the Y direction) orthogonal to the direction in which the reflection regions R of the adjacent pixels G continue.

That is because, when the insulating layer 40 is formed in the stripe shape, the step of the insulating layer 40 in each pixel G can be formed only along a predetermined direction (the Y direction), and the step of the insulating layer 40 included in one pixel G can be further reduced. Therefore, while the retardation is optimized in the reflection region R and the transmission layer T, respectively, the alignment defects caused by the step of the insulating layer 40 can be effectively prevented from occurring.

Accordingly, with such a configuration as shown in FIG. 6B, the number of sides of the step of the insulating layer 40 included in one pixel G can be made to one, and the liquid crystal display device 10 can have more excellent display characteristics.

In addition, the step in the insulating layer 40 is preferably formed in a tapered shape. That is because, if the step were formed vertical, the adherence between the electrodes 33 or the like formed on the insulating layer 40 may be reduced and the wiring lines may be disconnected, such that defective display may occur.

In addition, the step in the insulating layer 40 is preferably formed in the reflection region R. That is because, when the step of the insulating layer 40 exists in the transmission region T, display characteristics in the transmissive display can be degraded. For example, in the case of the liquid crystal display device 10 of the normally white mode, the alignment defects may occur in the step, such that light leakage may occur.

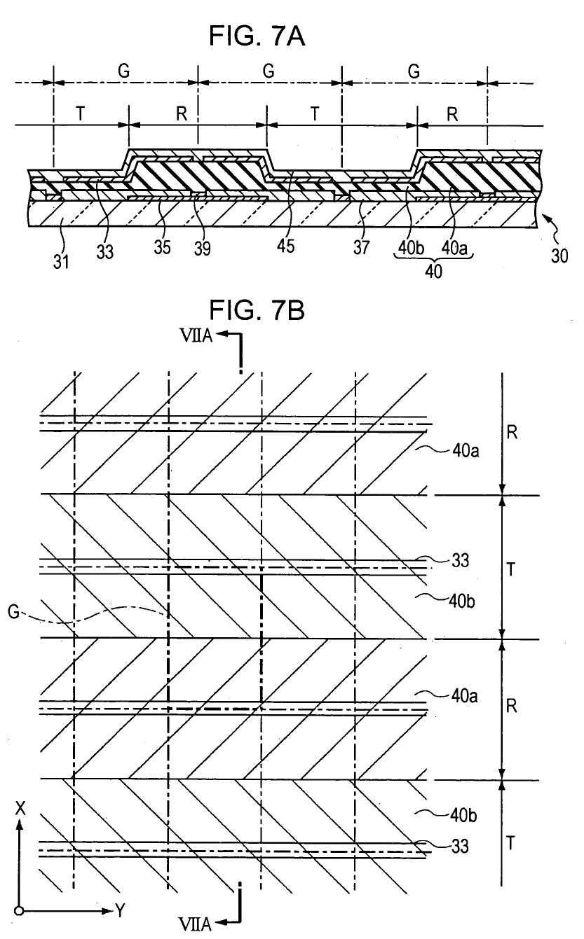

Moreover, in order to optimize the retardation, the reflection region R has a thin layer portion and the transmission region T has a thick layer portion in the liquid crystal material layer 21. As described above, the insulating layer 40 is formed in the reflection region, but the insulating layer 40 having a thick portion 40a corresponding to the reflection region R and a thin portion 40b corresponding to the transmission region T can be formed, as shown in FIGS. 7A and 7B. In this case, the thick portion 40a in the insulating layer 40 is formed across two adjacent pixels G along the direction (the X direction) in which the reflection regions R of the adjacent pixels G continue.

In addition, when the insulating layer is provided only in the reflection region R or when the insulating layer 40 having the thick portion 40a in the reflection region R and the thin portion 40b in the transmission region T is provided, the liquid crystal material layer 21 includes the thin layer portion corresponding to the reflection region R and the thick layer portion corresponding to the transmission region T. The thin layer portion corresponding to the reflection region R is formed across two adjacent pixels G along the direction in which the reflection regions R of the adjacent pixels G continue.

(6) Scanning Electrode and Alignment Film

In addition, on the insulating layer 40, the scanning electrodes 33 made of transparent conductor, such as ITO (indium tin oxide) or the like, are formed. The scanning electrodes 33 are formed in stripe shapes. In this case, a plurality of transparent electrodes are arranged in parallel. On the scanning electrodes 33, the alignment film 45 made of polyimide resin is formed.

4. Element Substrate

(1) Basic Configuration

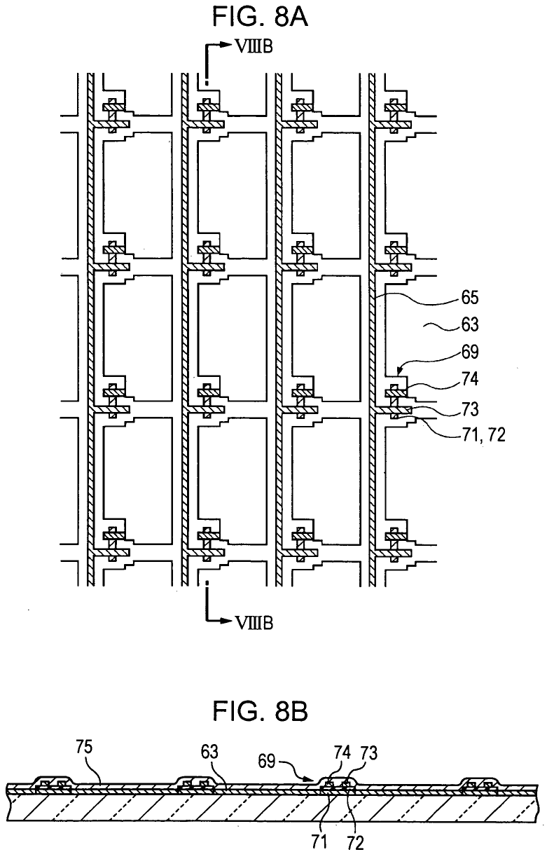

In addition, as shown in FIGS. 8A and 8B, the element substrate 60 basically includes the base substrate 61 made of a glass substrate or the like, the data lines 65, the TFD elements 69 as switching elements, and the pixel electrodes 63. Further, on the pixel electrodes 63, an alignment film 75 made of polyimide resin or the like is formed. Further, on the outer surface of the base substrate 61, a retardation plate 77 (quarter wave plate) and a polarizing plate 79 are disposed.

Moreover, FIG. 8A is a schematic plan view showing the element substrate 60, and FIG. 8B is a schematic cross-sectional view showing the element substrate 60. In addition, the alignment film, the polarizing plate, and the like are properly omitted.

(2) Data Line and Relay Wiring Line

As shown in FIG. 8A, the data lines 65 on the element substrate 60 are formed in stripe shapes. In this case, a plurality of wiring lines are arranged in parallel. In addition, though not shown, the relay wiring lines are provided to be electrically connected to the scanning electrodes 33 on the color filter substrate 30 via the sealing material including the conductive particles, on the side extending vertically with respect to the side near a mounting region of a driver or the like.

The data lines 65 and the relay wiring lines are formed at the same time when two-terminal nonlinear elements described below are formed in view of simplicity of a manufacturing process and reduction in electrical resistance. Therefore, a tantalum layer, a tantalum oxide layer, and a chromium layer are sequentially formed.

(3) Pixel Electrode

The pixel electrodes 63 are electrically connected to the data lines 65 through the switching elements 69. In addition, the pixel electrodes 63 are disposed in a matrix shape between the data lines 65.

The pixel electrodes 63 can be made of a transparent conductive material, such as ITO (indium tin oxide) or IZO (indium zinc oxide).

(4) Switching Element

In addition, on the element substrate 60, the TFD elements 69 as the switching elements 69 are formed to electrically connect the data lines 65 to the pixel electrodes 63. In general, the TFD element 69 has a sandwich structure in which a first element electrode 71 made of a tantalum (Ta) alloy, an insulating film 72 made of a tantalum oxide (Ta₂O₅), and second element electrodes 73 and 74 made of chromium (Cr) are sequentially laminated. The TFD element 69 has a diode switching characteristic in positive and negative directions. If a voltage more than a threshold value is applied between the first element electrode 71 and the second element electrodes 73 and 74, the TFD element 69 becomes conductive.

In addition, two of the TFD elements 69a and 69b are formed to be interposed between the data lines 65 and the pixel electrodes 63. The first TFD element 69a and the second TFD element 69b are preferably provided to have reverse diode characteristics.

That is because, with such a configuration, symmetric positive and negative pulse waveforms can be used as the waveform of a voltage to be applied, and thus the liquid crystal material in the liquid crystal display device can be prevented from being degraded. That is, in order to prevent the liquid crystal material from being degraded, a diode switching characteristic is preferably symmetric in the positive and negative directions. With two of the TFD elements 69a and 69b, which are connected to each other in series in reverse directions, the symmetric positive and negative pulse waveforms can be used.

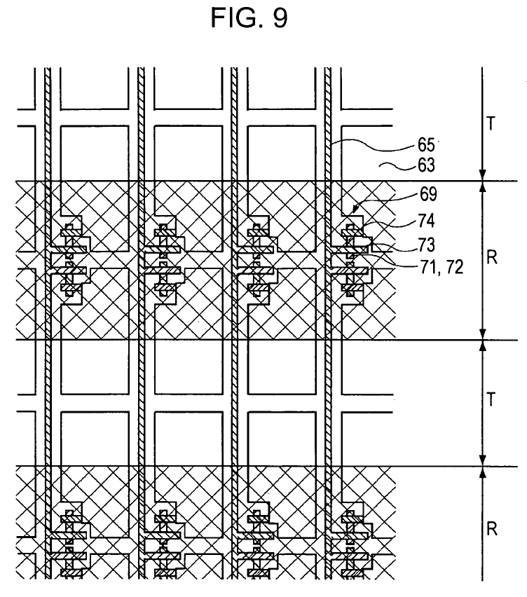

In addition, in the liquid crystal display device 10 of the invention in which the reflection regions R are disposed on the opposing sides of adjacent pixels, the TFD element 69 is preferably disposed in the reflection region R in each pixel, as shown in FIG. 9.

That is because, if the TFD element 69 is disposed in the transmission region T, light leakage may occur, such that contrast may be significantly reduced. Further, there may be a region which is not fundamentally driven by a voltage. On the contrary, contrast in the reflection region R tends be slightly low, as compared to the transmission region R. Therefore, an influence on the contrast caused by light leakage becomes small, and an influence on display characteristics can be made relatively small, as compared to the case in which the TFD element 69 is disposed in the transmission region T.

Accordingly, with the TFD element 69 disposed in the reflection region R in which the light reflecting film 35 is formed, an influence on the display characteristics can be made small and also the light shielding film can be easily formed in a simple shape, since the TFD elements 69 are disposed close to each other.

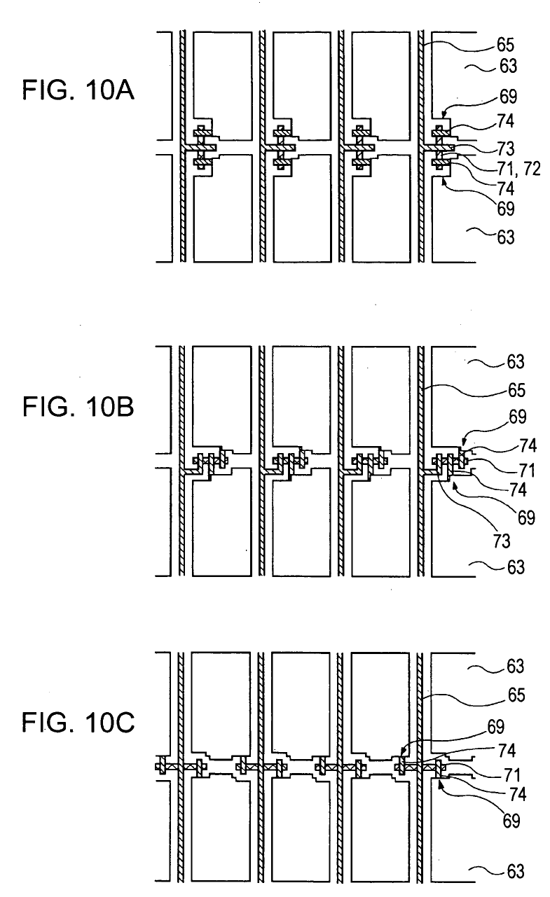

In addition, when the TFD element 69 is disposed in the reflection region R in each pixel, a portion of electrodes constituting the TFD elements 69 corresponding to two pixels which are adjacent in the direction along the data lines 65 or in an oblique direction along the data line 65 is preferably shared, as shown in FIGS. 10A to 10C.

That is because, the TFD elements 69 corresponding to adjacent pixels in a predetermined direction can be disposed across the same region between the pixels. Therefore, the region between the pixels in which the TFD elements 69 are disposed can be made small, thereby increasing the pixel area.

More specifically, FIG. 10A shows an example of the configuration in which the first element electrode 71 constituting the TFD elements 69 corresponding to two adjacent pixel electrodes 63 along the data lines 65 are disposed across two pixels along the data lines 65 to be shared.

In addition, FIG. 10B shows an example of the configuration in which the first element electrode 71 constituting the TFD elements 69 corresponding to two adjacent pixel electrodes 63 along the data lines 65 are disposed between the two pixel electrodes 63 in a direction orthogonal to the data lines 65 to be shared.

Further, FIG. 10C shows an example of the configuration in which the first element electrode 71 constituting the TFD elements 69 corresponding to the two adjacent pixel electrodes 63 in an oblique direction along the data lines 65 are disposed across both sides with the data line 65 interposed therebetween to be shared.

In the example of FIG. 10A, the pixel area is widely ensured in each pixel electrode 63 such that the second element electrode 74 constituting the TFD element 69 connected to the adjacent pixel electrode 63 does not enter. In addition, in the examples of FIGS. 10B and 10C, a portion of the second element electrode 74 connected to the adjacent pixel electrode 63 enters in each pixel electrode. However, since the area required for disposing the TFD element 69 connected to the pixel electrode 63 itself is made small, the pixel area is widely ensured in each pixel as a whole.

Since the length of a current path from the connection point between the data line 65 and the TFD element 69 to the connection point between the TFD element 69 and the pixel electrode 63 is equal in each pixel electrode 63, the resistance value of a current with respect to each pixel can be equalized, and display characteristics can be enhanced. Therefore, it is preferable to implement the configurations shown in FIG. 10A or 10C.

Moreover, aperture ratios are measured in the element substrate of the related art shown in FIGS. 16A to 16C and the element substrate used in the liquid crystal display device according to the invention shown in FIGS. 10A to 10C. In the configuration of the element substrate of the related art shown in FIGS. 16A to 16C, the aperture ratio is 63.83%. On the other hand, in the configurations shown in FIGS. 10A to 10C, the aperture ratios are 64.49%, 64.74%, and 65.06%, respectively.

Therefore, in the electro-optical device according to the invention, it is appreciated that the aperture area of each pixel is increased, as compared to the related art.

### SECOND EMBODIMENT

A second embodiment of the invention relates to a method of manufacturing an electro-optical device having a pair of substrates with an electro-optical material layer interposed therebetween and a plurality of pixels, each having a reflection region and a transmission region. The method of manufacturing an electro-optical device includes forming a light reflecting film on a substrate, such that the reflection regions are formed on opposing sides of adjacent pixels, and forming an insulating layer in at least the reflection region such that the thicknesses of the electro-optical material layer in the reflection region and the transmission region are made different from each other. Here, the insulating layer is formed across two adjacent pixels along a direction in which the reflection regions of the adjacent pixels continue.

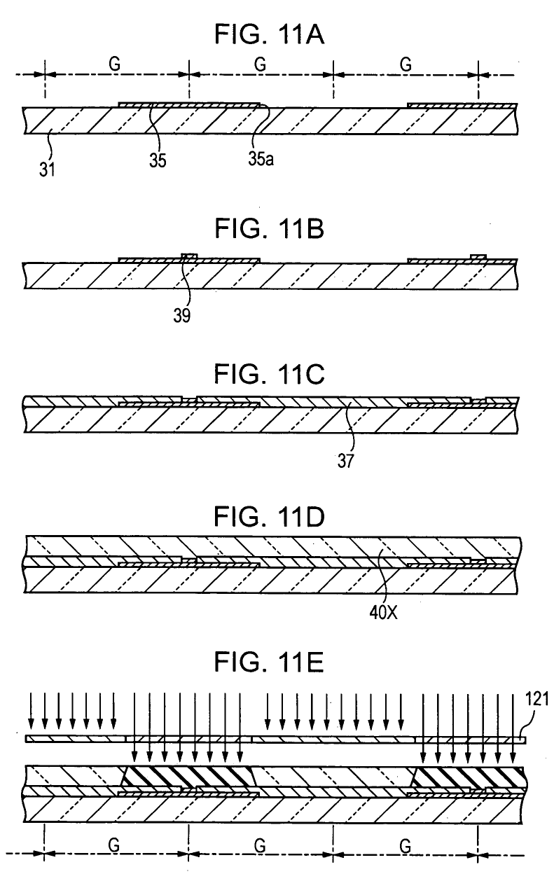

Hereinafter, as an example of the method of manufacturing an electro-optical device according to the second embodiment, a method of manufacturing an electro-optical device according to the first embodiment will be described with reference to FIGS. 11A to 13E.

1. Manufacturing Process of Color Filter Substrate

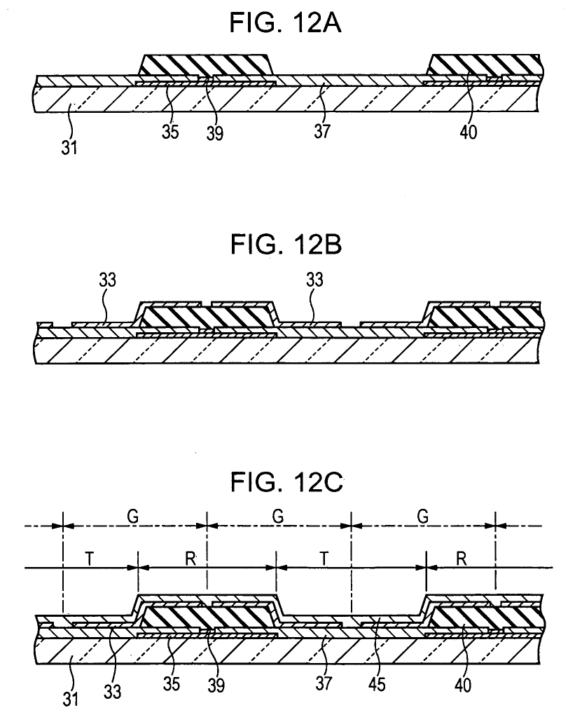

As shown in FIGS. 11A to 12C, the color filter substrate 30 can be manufactured by sequentially forming the light reflecting film 35, the light shielding film 39, the colored layer 37, the insulating layer 40, the scanning electrodes 33, the alignment film 45, and the like on a place corresponding to the display region in the base substrate 31 made of glass substrate.

Here, in the liquid crystal display device 10 to be manufactured according to the present embodiment, the reflection regions R are disposed on the opposing sides of adjacent pixels G. For this reason, in the color filter substrate 30, the insulating layer 40 is formed in the reflection region R, such that the thicknesses of the liquid crystal material layer in the reflection region R and the transmission region T are made different from each other. The insulating layer 40 is formed across two adjacent pixels G along the direction in which the reflection regions R of the adjacent pixels G continue.

Therefore, the manufacturing process of the color filter substrate includes forming the light reflecting film 35 and the insulating layer 40 over two adjacent pixels G along the direction in which the reflection regions R of adjacent pixels G continue.

That is, a metal material, such as aluminum or silver, is coated on a substrate by a deposition method or a sputtering method and then is patterned in a predetermined shape by an etching method or the like. Then, as shown in FIG. 11A, the light reflecting film 35 is formed such that the reflection regions R are disposed on the opposing sides of adjacent pixels G.

In addition, as shown in FIGS. 11D to 12A, a transparent resin layer 40X made of acryl resin is formed on the substrate on which the colored layer 37 or the like is formed and then is exposed and developed through a pattern mask 121, which is patterned in a predetermined shape, such that the insulating layer 40 corresponding to the reflection region R can be formed.

Moreover, a method of forming the light shielding film 35, the colored layer 37 or the like is not particularly limited. These can be formed by a known method.

2. Manufacturing Process of Element Substrate

(1) Formation of First Element Electrode

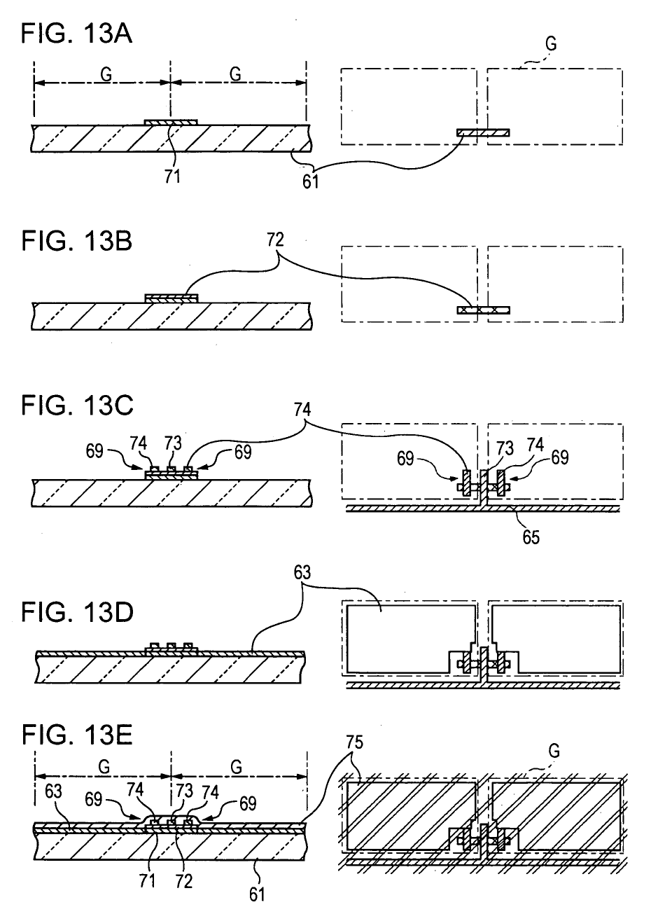

In the element substrate 60, first, the first element electrode 71 is formed on the substrate 61 made of a glass substrate, as shown in FIG. 13A. The first element electrode 71 made of, for example, a tantalum alloy can be formed by a sputtering method or an electron-beam deposition method. At this time, before the first element electrode 71 is formed, the adherence of the first element electrode 71 to the second glass substrate 61 can be significantly enhanced, and the diffusion of impurities from the second glass substrate 61 into the first element electrode 71 can be effectively suppressed. Therefore, the insulating film made of a tantalum oxide (Ta₂O₅) may be formed on the base substrate 61.

At this time, in the method of manufacturing an electro-optical device according to the present embodiment, the first element electrode 71 is shared by the TFD elements 69 corresponding to two adjacent pixels 63 along the data lines 65 or in the oblique direction to the data lines 65. Therefore, the first element electrode 71 is preferably formed across two adjacent pixels G. That is because the formation region of the TFD element 69 can be made small and the pixel electrode 63 can be made large, such that each pixel area is increased. As a result, it is possible to manufacture the electro-optical device with enhanced display characteristics, such as contrast or the like.

Next, as shown in FIG. 13B, the surface of the first element electrode 71 is oxidized by an anodic oxidation method to form an oxide film 72. More specifically, after the substrate on which the first element electrode 71 is formed is dipped in an electrolyte, such as a citrate solution or the like, a predetermined voltage is applied between the electrolyte and the first element electrode 71, such that the surface of the first element electrode 71 can be oxidized.

(2) Formation of Second Element Electrode and Data Line

Next, on the substrate including the first element electrode 71, a metal film is entirely formed by a sputtering method or the like and then is patterned by a photolithographic method. Then, as shown in FIG. 13C, the second element electrodes 73 and 74 and the data line 65 are formed. In such a manner, the TFD element 69 and the data line 65 can be formed.

(3) Formation of Pixel Electrode

Next, as shown in FIG. 13D, a transparent conductive layer made of a transparent conductive material, such as ITO (indium tin oxide) or the like, is formed by a sputtering method or the like and then is patterned by a photolithographic method, such that the pixel electrode 63 electrically connected to the TFD element 69 is formed.

(4) Formation of Alignment Film

Next, as shown in FIG. 13E, the alignment film 75 made of polyimide resin or the like is formed on the element substrate 60 on which the pixel electrode 63 is formed, such that the element substrate 60 can be manufactured.

3. Bonding Process

Next, though not shown in the drawings, the sealing material 23 is laminated so as to surround the display region on one of the color filter substrate 30 and the element substrate 60. Then, the other substrate overlaps to be hot-pressed, such that the color filter substrate 30 and the element substrate 60 are bonded to each other to constitute a cell structure.

4. Post-Process

Next, a liquid crystal material is injected into the cell from an injection opening provided in a portion of the sealing material and then is sealed by the opening-sealing material or the like.

Further, on the outer surfaces of the color filter substrate 30 and the element substrate 60, the retardation plates (quarter wave plates) and the polarizing plates are disposed and the driver is mounted. In addition, these are incorporated into a case, together with a backlight or the like, such that the liquid crystal device can be manufactured.

### THIRD EMBODIMENT

In the third embodiment, the transflective electro-optical device of the first embodiment is applied to an active-matrix-type liquid crystal display device using TFT elements (Thin Film Transistors), which are three-terminal active elements, as switching elements.

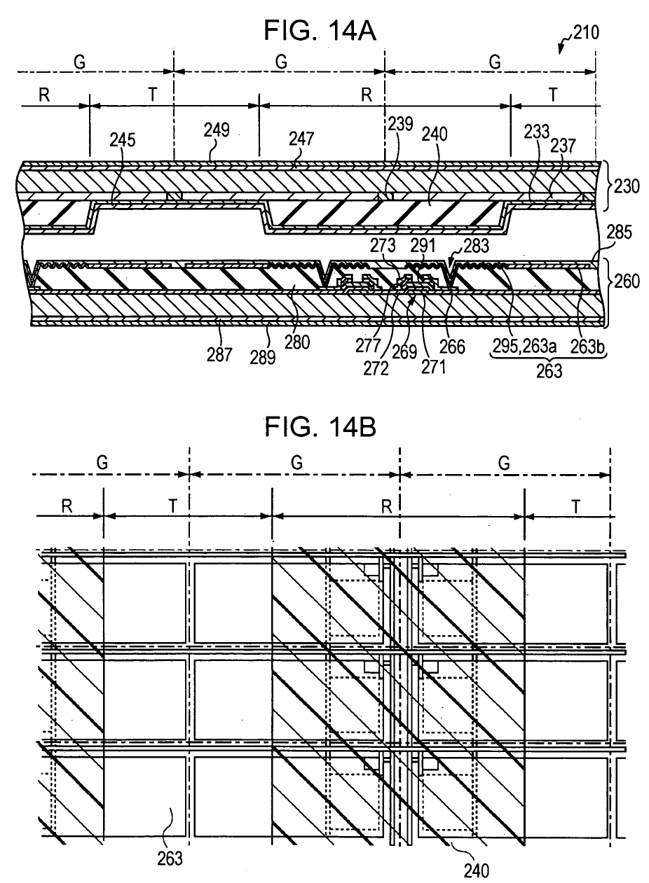

FIG. 14A is a cross-sectional view showing a liquid crystal display device 210 according to the third embodiment, and FIG. 14B is a plan view showing the liquid crystal display device 210. As shown in FIG. 14A, a counter substrate 230 and an element substrate 260 are bonded to each other in the peripheral portions thereof with a sealing material and a liquid crystal material is injected into a gap which is surrounded by the counter substrate 230, the element substrate 260, and the sealing material, such that the liquid crystal display device 210 is formed.

In addition, the counter substrate 230 made of glass, plastic, or the like includes a color filter, that is, a colored layer 237, a counter electrode 233 formed on the colored layer 237, and an alignment film 245 formed on the counter electrode 233. In addition, between the colored layer 237 and the counter electrode 233 in the reflection region R, an insulating layer 240 for optimizing the retardation is provided.

Here, the counter electrode 233 is a planar electrode made of ITO on the entire surface of the counter substrate 230. In addition, the colored layer 237 includes a color filter element of one of R (red), G (green), and B (blue) or C (cyan), M (magenta), and Y (yellow) at a position facing the pixel electrode 263 on the element substrate 260. In the vicinity of the colored layer 237, a black mask or a black matrix, that is, a light shielding film 239, is provided at a position not facing the pixel electrode 263.

In addition, the element substrate 260 facing the counter substrate 230 is made of glass., plastic, or the like and includes TFT elements 269, which are active elements and which serve as switching elements, and pixel electrodes 263 formed on the TFT element 269 with a transparent insulating layer 280 interposed therebetween.

Here, the pixel electrode 263 is formed as a light reflecting film 295 (263a) for performing reflection display in the refection region R and is formed as a transparent electrode 263b made of ITO in the transmission region T. In addition, the light reflecting film 295 serving as the pixel electrode 263a is made of a light reflecting material, such as Al (aluminum) and Ag (silver). On the pixel electrode 263, an alignment film 285 is formed while being subjected to rubbing treatment as alignment treatment.

On the outer surface (that is, the upper side of FIG. 14A) of the counter substrate 230, a retardation plate 247 is formed, and a polarizing plate 249 is formed on the retardation plate 247. Similarly, on the outer surface (that is, the lower side of FIG. 14A) of the element substrate 260, a retardation plate 287 is formed, and a polarizing plate 289 is formed below the retardation plate 287. Below the element substrate 260, a backlight unit (not shown) is disposed.

In addition, the TFT element 269 has a gate electrode 271 formed on the element substrate 260, a gate insulating film 272 formed on the gate electrode 271 above the entire element substrate 260, a semiconductor layer 291 formed on the gate electrode 271 with the gate insulating film 272 interposed therebetween, a source electrode 273 formed in one side of the semiconductor layer 291 with a contact electrode 277 interposed therebetween, and a drain electrode 266 formed in the other side of the semiconductor layer 291 with the contact electrode 277 interposed therebetween.

In addition, the gate electrode 271 extends from a gate bus wiring line (not shown), and the source electrode 273 extends from a source bus wiring line (not shown). In addition, the plurality of gate bus wiring lines extending in the horizontal direction of the second substrate 260 are formed at constant intervals in parallel in the vertical direction, and the plurality of source bus wiring lines extending in the vertical direction so as to cross the gate bus wiring lines with the gate insulating film 272 interposed therebetween are formed at constant intervals in parallel in the horizontal direction.

The gate bus wiring lines are connected to a liquid crystal driving IC (not shown) to serve as scanning lines, for example. On the other hand, the source bus wiring lines are connected to another driving IC (not shown) to serve as signal lines, for example.

In addition, the pixel electrode 263 is formed in the region, excluding a portion corresponding to the TFT element 269 in the rectangular region which is divided by the gate bus wiring lines and the source bus wiring lines intersecting each other.

Here, the gate bus wiring lines and the source electrode can be made of chromium, tantalum, or the like. In addition, the gate insulating film 272 is made of silicon nitride (SiNx), silicon oxide (SiOx), or the like. The semiconductor layer 291 can be made of doped a-Si, polycrystalline silicon, CdSe, or the like. Further, the contact electrode 277 can be made of a-Si. The source electrode 273, the source bus wiring lines formed integrally thereto, and the drain electrode 266 can be made of titanium, molybdenum, aluminum, or the like.

In addition, an organic insulating layer 280 is formed on the entire second substrate 260 to cover the gate bus wiring lines, the source bus wiring lines, and the TFT element 269. However, in the portion corresponding to the drain electrode 266 of the organic insulating film 280, a contact hole 283 is formed, through which the pixel electrode 263 and the drain electrode 266 of the TFT element 269 are electrically connected.

In addition, in the organic insulating film 280, a resin layer having a concavo-convex pattern constituted by a regularly or irregularly repeated pattern having a convex portion and a concave portion is formed in a scattering shape in the region corresponding to the reflection region R. As a result, a light reflecting film 295 (263a) to be laminated on the organic insulating film 280 has a light reflecting pattern by a concave-convex pattern, similarly to the organic insulating film 280. The concave-convex pattern is not formed in the transmission region T.

In the liquid crystal display device 210 having such a structure, external light such as sunlight or indoor light is incident on the liquid crystal display device 210 from the first substrate 230 at the time of the reflection display. Further, light passes through the colored layer 237 and the liquid crystal material 221 to reach the light reflecting film 295. Light is reflected from the light reflecting film 295 to pass through the liquid crystal material 221 and the colored layer 237 again. Then, light is finally emitted from the liquid crystal display device 210, such that the reflective display is performed.

On the other hand, the backlight unit (not shown) is turned on at the time of transmission display. Light emitted from the backlight unit sequentially passes through the transmissive transparent electrode 263b, the colored layer 237, and the liquid crystal material 221 to be emitted outside a liquid crystal panel 220, such that transmission display is performed.

In addition, in the liquid crystal display device 210 of the third embodiment, the reflection regions R are disposed on the opposing sides of the adjacent pixels G, as shown in FIGS. 14A and 14B. The above-described insulating layer 240 on the counter substrate 230 is formed across two adjacent pixels G along the direction in which the reflection regions of the adjacent pixels G continue.

Therefore, similarly to the liquid crystal display device having the TFD element described in the first embodiment, the step of the insulating layer 240 included in one pixel G is reduced, and thus the alignment defects of the liquid crystal material can be reduced, which makes it possible to enhance display characteristics.

### FOURTH EMBODIMENT

As the fourth embodiment according to the invention, an electronic apparatus having a liquid crystal display device serving as the electro-optical device of the first embodiment will be described specifically.

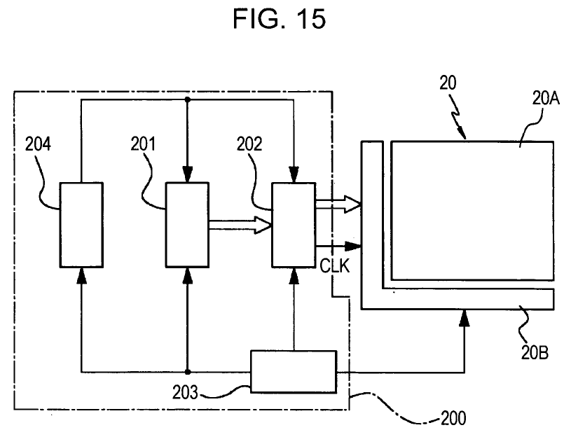

FIG. 15 is a schematic view showing an overall configuration of the electronic apparatus of the present embodiment. The electronic apparatus has a liquid crystal panel 20 provided in the liquid crystal display device and a control unit 200 for controlling the liquid crystal panel 20. In addition, in FIG. 15, the liquid crystal panel 20 is conceptually divided into a panel structure 20a and a driving circuit 20b having a semiconductor element (IC) or the like. In addition, the control unit 200 preferably has a display information output source 201, a display information processing circuit 202, a power supply circuit 203, and a timing generator 204.

In addition, the display information output source 201 includes a memory, such as a ROM (Read Only Memory) or a RAM (Random Access Memory), a storage unit, such as a magnetic recording disc or an optical recording disc, and a tuning circuit for tuning and outputting a digital image signal. Based on various clock signals generated by the timing generator 204, the display information output source 201 may supply display information of image signals having a predetermined format to the display information processing circuit 202.

In addition, the display information processing circuit 202 includes various known circuits, such as a serial-to-parallel conversion circuit, an amplification/inversion circuit, a rotation circuit, a gamma correction circuit, a clamp circuit, and the like. The display information processing circuit 202 preferably processes the input display information to supply the image information and the clock signal CLK to the driving circuit 20b. Further, the driving circuit 20b preferably includes a first electrode driving circuit, a second electrode driving circuit, and a check circuit. The power supply circuit 203 has a function of supplying a predetermined voltage to each of the above-described parts.

The electronic apparatus of the present embodiment has a liquid crystal display device in which the insulating layer for forming the multi-gap structure is formed across two adjacent pixels along the direction in which the reflection regions of the adjacent pixels continue. Therefore, the electronic apparatus, which can perform image display with excellent display characteristics, can be implemented.

According to the invention, the insulating layer for forming the multi-gap structure is formed across two adjacent pixels along the direction in which the reflection regions of the adjacent pixels continue, such that the step of the insulating layer is reduced and thus the electro-optical device having excellent display characteristics can be implemented. Therefore, the invention can be applied to an electronic apparatus including an electro-optical device, such as a liquid crystal display device or an electronic apparatus, such as a liquid crystal television, a view finder-type or monitor-direct-view-type video tape recorder, a car navigation device, a pager, an electrophoretic device, an electronic organizer, an electronic calculator, a word processor, a workstation, a video phone, a POS terminal, an electronic apparatus having a touch panel, or the like, in addition to a cellular phone, a personal computer, and the like.

The entire disclosure of Japanese Patent Application No. 2004-272890, filed Sep. 21, 2004, is expressly incorporated by reference herein.

What is claimed is:

1. An electro-optical device comprising:
a pair of substrates;
an electro-optical material layer interposed between the pair of substrates;
a plurality of pixels, each having a reflection region and a transmission region, a set of adjacent pixels of the pixels having sides that oppose each other and including reflection regions located at the opposing sides; and
an insulating layer formed in between the electro-optical material layer and one of the substrates, the insulation layer causing the electro-optical material layer to have a different thickness in the reflection region than in the transmission region, the insulating layer extending continuously from the reflection region of one of the adjacent pixels into the reflection region of the other of the adjacent pixels.

2. The electro-optical device according to claim 1,
wherein the insulating layer is formed in a stripe shape that extends continuously across pixels that are juxtaposed in a direction orthogonal to a direction from the one of the adjacent pixels to the other of the adjacent pixels.

3. The electro-optical device according to claim 1, wherein the insulating layer has a step formed in a tapered shape.

4. The electro-optical device according to claim 1, wherein the insulating layer has a step formed in the reflection region.

5. The electro-optical device according to claim 1, further comprising switching elements provided between the electro-optical material layer and one of the substrates, the switching elements being disposed in the reflection regions of the pixels.

6. The electro-optical device according to claim 5, further comprising a light shielding film disposed between the electro-optical material layer and one of the pair of substrates that overlaps one of the switching elements in plan view.

7. The electro-optical device according to claim 1, further comprising a light reflecting film formed with an opening, another set of adjacent pixels having transmission regions disposed on opposing sides of the other set of adjacent pixels, the opening in the light reflecting film being formed continuously in other set of adjacent pixels.

8. An electro-optical device comprising:
a pair of substrates with an electro-optical material layer interposed therebetween; and
a plurality of pixels, each having a reflection region and a transmission region,
wherein the reflection regions are disposed on opposing sides of adjacent pixels,
on one substrate of the pair of substrates, an insulating layer is formed to have a thick portion corresponding to the reflection region and a thin portion corresponding to the transmission region, such that the thicknesses of the electro-optical material layer in the reflection region and the transmission region are made different from each other, and
the thick portion is formed across two adjacent pixels along a direction in which the reflection regions of the adjacent pixels continue.

9. The electro-optical device according to claim 8,
wherein the thick portion and the thin portion in the insulating layer are formed in a stripe shape across the pixels that are arranged along a direction orthogonal to the direction in which the reflection regions of the adjacent pixels continue.

10. A method of manufacturing an electro-optical device, the electro-optical device having a pair of substrates with an electro-optical material layer interposed therebetween, and a plurality of pixels, each having a reflection region and a transmission region, the method of manufacturing an electro-optical device comprising:
forming a light reflecting film on a substrate, such that the reflection regions are formed on opposing sides of adjacent pixels; and
forming an insulating layer in at least the reflection region such that the thicknesses of the electro-optical material layer in the reflection region and the transmission region are made different from each other, the insulating layer being formed across two adjacent pixels along a direction in which the reflection regions of the adjacent pixels continue.
